(19) United States
(12) Patent Application Publication
(10) Pub. No.: US 2015/0296502 A1
(43) Pub. Date: Oct. 15, 2015

(54) ELECTRONIC DEVICE WITH MULTI-MODE RADIO CAPABILITIES

(71) Applicant: Koos Technical Services, Inc., Lake Mary, FL (US)

(72) Inventors: Edward C. Gerhardt, Todd, NC (US); Larry W. Koos, Sanford, FL (US); William M. Koos, Altamonte Springs, FL (US)

(21) Appl. No.: 14/683,808

(22) Filed: Apr. 10, 2015

Related U.S. Application Data
(60) Provisional application No. 61/978,615, filed on Apr. 11, 2014.

(51) Int. Cl. H04W 72/04; H04L 5/14; H04L 5/00

(52) U.S. Cl. CPC H04W 72/048; H04L 5/0007; H04L 5/14; H04W 88/06

(57) ABSTRACT

A radio device includes a radio circuit for establishing radio communications with plural network types. The radio circuit includes a cellular mode for conducting wireless communications with a cellular subscriber network; and a whitespace mode for conducting wireless communications using one or more whitespace channels identified in a current whitespace channel list obtained from a whitespace management database.

### RELATED APPLICATION DATA

This application claims the benefit of U.S. Provisional Patent Application No. 61/978,615, filed Apr. 11, 2014, the disclosure of which is incorporated herein by reference in its entirety.

### TECHNICAL FIELD OF THE INVENTION

The technology of the present disclosure relates generally to electronic devices and, more particularly, to an electronic device having a communications circuitry capable of communicating over multiple frequencies and corresponding protocols.

### BACKGROUND

There are a multitude of wireless communications standards and protocols in use by different types of radio devices. One commonly employed wireless radio access technology involves cellular communications between a network and a radio device. Some cellular networks employ protocols consistent with long term evolution (LTE), such as 4G technology. To access a cellular network, a radio device typically requires access credentials that are provided under a network service agreement with a cellular network operator. In some cases, temporary permission to use a network may be granted in a roaming mode. In this case, a service charge based on length of connectivity, network usage or other formulation may be charged to the owner of the radio device.

Cellular networks that operate using LTE signaling and protocols employ a frequency division duplexing (FDD) mode or a time division duplexing (TDD) mode. In an FDD mode, communications are conducted on an uplink channel and a downlink channel using paired frequency bands. In a TDD mode, one frequency is used for both the uplink and the downlink.

Another wireless radio access technology uses spectrum sharing in designated spectrum bands. An exemplary spectrum sharing technique involves use of television (TV) white spaces under regulations set forth by an appropriate regulatory agency. An exemplary regulatory agency that regulates the use of wireless spectrum is the U.S. Federal Communications Commission (FCC). Other countries may have similar regulatory entities.

In the U.S., for example, the FCC has eliminated analog TV broadcasts in favor of digital TV broadcasts. This has freed spectrum channels for use by unlicensed radio systems to offer various services, such as mobile communications and Internet access. In this context, the freed spectrum is commonly referred to as TV white space (or TVWS) but other types of white spaces are possible. In the case of TV white space, the white space is comprised of unused spectrum that is interleaved with spectrum used by incumbent radio devices in the channel 2 to channel 51 range (corresponding to 54 MHz to 698 MHz). Exemplary incumbent radio devices for TV white space include television broadcasters, wireless microphone devices and other priority users of television channels. Under FCC regulations, for example, radio devices that use TVWS must register with a central database server (also referred to as a spectrum management server) and receive a channel list (also referred to as a channel map) of available channels for which the radio device may use in a shared environment with other TV band devices (TVBDs). The channel list that is generated for a radio device is generated by the central database server based on the location of the radio device. Under current regulations in the U.S., a TVBD must request a new channel map every 24 hours or when the TVBD moves to a new location (e.g., moves more than 50 meters).

### BRIEF DESCRIPTION OF THE DRAWINGS

FIG. 1 is a schematic block diagram of an electronic device.

FIG. 2 is a schematic view of a communication environment for the electronic device.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of an electronic device and methods of carrying out wireless communications. In one embodiment, the electronic device is a radio modem for use in establishing wireless communications. In this embodiment, the radio modem may have core communications circuitry and control circuitry for the communications circuitry, and have no or few other components for conducting other functions. Also, in this embodiment, the radio modem is used to establish wireless communications for another electronic device (e.g., a computer, electronics in a vehicle, etc.) to allow that device to participate in wireless communications with other devices or establish network or Internet connectivity. In the typical implementation of this embodiment, the radio modem is a separate device from the device for which the radio modem establishes communications and the radio modem and the device are operatively connected via a cable or short-range wireless link (e.g., WiFi).

In another embodiment, the electronic device conducts one or more functions and relies on an included radio modem having the capabilities described in this disclosure for wireless communications. For instance, the electronic device may be a mobile telephone, a tablet computer, or other device. It will be appreciated, however, that the disclosed radio capabilities may be incorporated into or connected to a wide range of electronic devices.

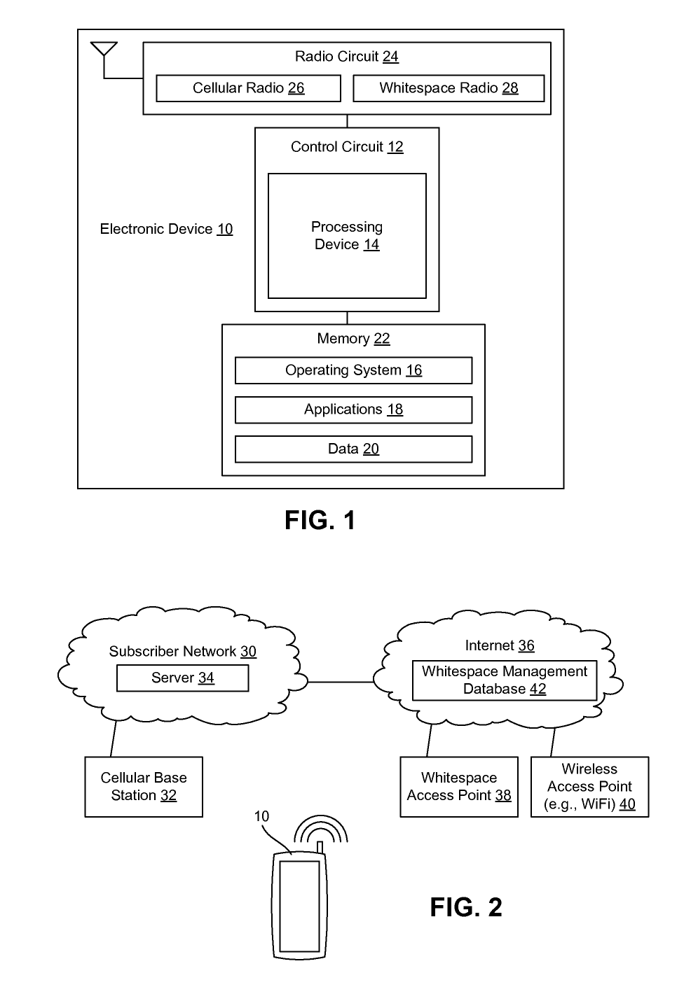

With initial reference to FIG. 1, a schematic block diagram of an electronic device 10 is illustrated. The electronic device 10 includes a control circuit 12 that is responsible for overall operation of the electronic device 10, including controlling wireless communications. The control circuit 12 may include a processor 14 that executes an operating system 16 and, if applicable, various applications 18. Typically, control over wireless communications is embodied as part of the operating system 16. In other embodiments, this functionality may be embodied as a dedicated application.

The operating system 16, the applications 18, and stored data 20 (e.g., data associated with the operating system 16, the applications 18, and user or data files), are stored on a memory 22. The operating system 16 and applications 18 are embodied in the form of executable logic routines (e.g., lines of code, software programs, etc.) that are stored on a non-transitory computer readable medium (e.g., the memory 22) of the electronic device 10 and are executed by the control circuit 12. The described control over wireless communications and radio operations may be thought of as a method that is carried out by the electronic device 10.

The processor 14 of the control circuit 12 may be a central processing unit (CPU), microcontroller, or microprocessor. The processor 14 executes code stored in a memory (not shown) within the control circuit 12 and/or in a separate memory, such as the memory 22, in order to carry out operation of the electronic device 10. The memory 22 may be, for example, one or more of a buffer, a flash memory, a hard drive, a removable media, a volatile memory, a non-volatile memory, a random access memory (RAM), or other suitable device. In a typical arrangement, the memory 22 includes a non-volatile memory for long term data storage and a volatile memory that functions as system memory for the control circuit 12. The memory 22 may exchange data with the control circuit 12 over a data bus. Accompanying control lines and an address bus between the memory 22 and the control circuit 12 also may be present. The memory 22 is considered a non-transitory computer readable medium.

The electronic device 10 includes communications circuitry that enables the electronic device 10 to establish various wireless communication connections. In the exemplary embodiment, the communications circuitry includes a radio circuit 24. The radio circuit 24 includes one or more radio frequency transceivers and an antenna assembly (or assemblies). The electronic device 10 is a multi-mode device capable of communicating using more than one radio access technology, using more than one communications standard and/or over more than one radio frequency band. To support these communications capabilities, the radio circuit 24 represents one or more than one radio transceiver, one or more than one antenna, tuners, impedance matching circuits, and any other components needed for the various supported frequency bands and radio access technologies. The radio circuit 24 further represents any radio transceivers and antennas used for local wireless communications directly with another electronic device, such as over a Bluetooth interface.

In one embodiment, the radio circuit 24 includes a cellular radio 26 and a whitespace radio 28. The radios 26, 28 may be embodied with separate electrical components. Alternatively, the radios 26, 28 are embodied by different logical elements and may share electrical components, or may be integrated into a single electrical component. For instance, the electronic device 10 may have cellular radio hardware that operates in conventional cellular carrier bands (e.g., channels designated by the appropriate regulatory agency as cellular channels) and is further configured to tune to whitespace bands (e.g., channels designed by the appropriate regulatory agency as whitespace channels) and operate in the whitespace bands using LTE signaling and protocols under an appropriate one of FDD or TDD.

With additional reference to FIG. 2, schematically shown is a communications environment for the electronic device 10. In the communications environment, the electronic device 10 may carry out wireless communications. To conduct wireless communications, the electronic device 10 establishes network connectivity with one or more networks.

In some situations, the network connection for conducting wireless communications is made with a cellular subscriber network 30 that services the physical geo-location of the electronic device 10. In most cases, the network 30 is a cellular network operated by a respective cellular service telephone company. Exemplary network access technologies for the network 30 are typically cellular circuit-switched network technologies and include, but are not limited to, global system for mobile communications (GSM), code division multiple access (CDMA), wideband CDMA (WCDMA), and advanced or alternative versions of these standards. The networks may support general packet radio service (GPRS), universal mobile telecommunications system (UMTS), 3G, 4G long-term evolution (LTE), or other standards.

In one embodiment, the communications between the electronic device 10 and the subscriber network 30 are established by way of a transmission medium of the subscriber network 30. The transmission medium may be any appropriate device or assembly, but is typically a communications base station 32 (e.g., cellular service towers, also referred to as “cell” towers).

The communications between the electronic device 10 and the base station 32 are performed by the cellular radio 26. These communications follow an appropriate protocol and signaling standard. In one embodiment, the protocol and signaling standard is LTE operating in an FDD mode using paired frequency bands respectively for an uplink and a downlink or in a TDD mode using a single frequency band for both an uplink and a downlink.

The network 30 supports communications such as, but not limited to, voice communications (e.g., telephone calls), video communications (e.g., video telephony), messaging (e.g., instant messaging, text and multimedia messaging, and electronic mail messaging), data transfers, and browsing of the Internet 36. To support the communications activity of the electronic device 10, the network 30 may include a server 34 (or servers). The server 34 may be configured as a typical computer system used to carry out server functions and may include a processor configured to execute software containing logical instructions that embody the functions of the server 34 and a memory to store such software and related data.

There are situations where the network connection for conducting wireless communications is made with a network other than the cellular subscriber network 30. For instance, the electronic device 10 may communicate with the Internet 36 or gain access to other wireless services via a whitespace access point 38 (sometimes referred to as a whitespace hub). The whitespace access point 38 may be part of a whitespace-based local area network (LAN) and/or connect to the Internet with an appropriate modem. Depending on regulations governing the electronic device 10, the electronic device 10 may register with a whitespace management database 42 to obtain a whitespace channel list of available whitespace channels. As indicated, whitespace channels may be television channels that are not occupied by an incumbent user. White space channels may include alternative bands or bands in addition to TVWS bands. In many countries, whitespace channels include channels in the 700 MHz band (e.g., 698 MHz to 806 MHz). In the U.S., the upper 700 MHz band (e.g., 758 MHz to 803 MHz) are designated as public safety bands. Therefore, it is possible that the electronic device 10 is configured to carry out cellular operations and operations in non-cellular and/or non-whitespace bands (e.g., public safety bands) using LTE signaling and protocols under an appropriate one of FDD or TDD. It is further possible that the electronic device 10 is configured to carry out cellular operations, operate in whitespace bands using LTE signaling and protocols under an appropriate one of FDD or TDD, and operate in non-whitespace bands (e.g., public safety bands) using LTE signaling and protocols under an appropriate one of FDD or TDD.

The communications between the electronic device 10 and the whitespace access point 38 are performed by the whitespace radio 28. These communications follow an appropriate protocol and interfacing standard. In one embodiment, the protocol and signaling standard is LTE operating in a TDD mode using a single frequency band for both an uplink and a downlink. In other embodiments, it is possible to use an FDD mode when communicating over available whitespace spectrum. For these purposes, the electronic device 10 may be configured to operate using LTE protocols and signaling standards in whitespace bands and/or any other appropriate bands.

In still other situations, the electronic device 10 may communicate with the Internet 36 or gain access to other wireless services via another type of connection. For example, the electronic device 10 may establish connectivity to a wireless access point 40 using a packet-switched protocol, such as IEEE 802.11a, IEEE 802.11b, IEEE 802.11g or IEEE 802.11n (commonly referred to as WiFi). Other LAN-based protocols are possible, such as WiMax under IEEE 802.16. The access point 40 is typically, but not necessarily, a wireless router. The access point 40 may be part of a local area network (LAN) and/or connect to the Internet with an appropriate modem.

The electronic device 10 may include functionality to determine when to use one of the connectivity options (e.g., when to conduct wireless communications via the cellular base station 32 or via the whitespace access point 38). The decision process may be conducted by a decision engine embodied as executable instructions that are executed by the processing device 14 of the control circuit 12. In one embodiment, the decision engine has a set of configurable rules. The rules may be adjusted by user inputs and/or with updates to default settings. The decision may be made locally by the electronic device 10 with information that is known to the electronic device 10. Some of this information may be obtained from outside sources, such as a whitespace registration database that provide available channel maps.

One or more factors may be considered by the decision engine. Exemplary factors may include, but are not limited to:
whitespace channel availability (e.g., in densely populated areas or during public safety event, the availability of whitespace channels may be low or not existent);
quality of service offered by the subscriber network 30 versus quality of service offered by whitespaces (e.g., quality of service over whitespaces may be degraded when shared with other, interfering whitespace radio devices);
importance of the data communications (e.g., “mission critical” communications may require high reliability, which would tend to favor subscription access);
interference on the whitespace bands versus interference on the subscriber network bands;
cost metrics (e.g., whitespace cost (typically free) versus subscriber network cost), noting that there may be multiple forms of cost for subscriber network access such as a subscription cost for unlimited service, a cost per data quantity, a cost per connection time or session, etc.;
radio metrics (e.g., antenna height, range, location, power consumption, etc.) and relationship of the radio metrics to connectivity type;
suitability of the connection type for the intended wireless application (e.g., voice communications, data transfers, etc.); and
security of the connection types.

In some situations, more than one subscriber network 30 may be available. In this case, the electronic device 10 may use the decision to engine to consider one or more factors for each of the available subscriber networks 30 during the decision making process. If a determination is made to use a subscriber network 30 over whitespace access, then a further decision is made between or among the available subscriber networks 30.

When the electronic device 10 switches from using the subscriber network 30 (e.g., a cellular mode) to whitespace access (e.g., a whitespace mode), the radio circuit 24 makes corresponding changes in operation. The changes include changing operating channel(s) and changing to an appropriate connection mode (e.g., FDD or TDD) compatible with the desired connection type.

With continued reference to FIG. 1, the electronic device 10 may include other components to support various functions and features. These components will depend on the nature of the electronic device 10. For example, if the electronic device 10 is a mobile phone, the electronic device 10 may have a display, a speaker, a microphone, and other user-interactive components. As another example, if the electronic device 10 is a telemetry radio, the electronic device 10 may have an input to receive data from a sensor or may include a sensor.

To facilitate obtaining a whitespace channel list, the electronic device 10 may be location-aware. For instance, a global positioning system (GPS) receiver may be present to assist in determining the location of the electronic device 10. Also, to support communications in a cellular-based subscriber network, the electronic device 10 may include a subscriber identity module (SIM) card slot in which a SIM card is received. The SIM card may be operative in providing data used to connect with the subscriber network. The slot includes any appropriate connectors and interface hardware to establish an operative connection between the electronic device 10 and the SIM card.

In some instances, there is a desire to isolate a communications network (or communicating devices) from another network or the Internet. An example of such a network is an industrial telemetry network. Whitespace channels may provide suitable spectrum for use by the isolated network. But a completely isolated network would face a challenge in obtaining whitespace channel authorization due to an inability to contact a whitespace database at appropriate times (e.g., at least every 24 hours). To address this issue, at least one node in the network may include the electronic device 10. In this embodiment, the whitespace radio 28 may be used to participate in network communications and the cellular radio 26 may be activated at appropriate times to make connection to the whitespace database through an LTE cellular network to obtain appropriate whitespace authorization for the electronic device 10. Depending on use of whitespace spectrum permitted by regulation, the electronic device 10 also may obtain appropriate whitespace authorizations for other whitespace radios in the network. In one embodiment, the whitespace radio 28 may be disabled when the cellular radio 26 is activated. In other words, the electronic device 10 changes between whitespace and cellular modes to conduct different operations at different times. In this manner, the electronic device may have a controlled connection outside the isolated network to keep the network as isolated as possible. In one embodiment, the controlled cellular connection is for the single purpose of obtaining whitespace authorization(s).

Although certain embodiments have been shown and described, it is understood that equivalents and modifications falling within the scope of the appended claims will occur to others who are skilled in the art upon the reading and understanding of this specification.

What is claimed is:

1. A radio device, comprising:
a radio circuit for establishing radio communications with plural network types, the radio circuit configured to operate as a cellular radio in a cellular mode for conducting wireless communications with a cellular subscriber network and to operate as a whitespace radio in a whitespace mode for conducting wireless communications using one or more available whitespace channels.

2. The radio device of claim 1, wherein the available whitespace channels are identified as available in a current whitespace channel list obtained from a whitespace management database.

3. The radio device of claim 1, wherein the radio circuitry uses long term evolution (LTE) protocols and signaling in both the cellular and whitespace modes.

4. The radio device of claim 3, wherein the radio circuitry uses frequency domain division (FDD) in the cellular mode and uses time domain division (TDD) in the whitespace mode.

5. The radio device of claim 3, wherein the radio circuitry uses time domain division (TDD) in the cellular mode and uses frequency domain division (FDD) in the whitespace mode.

6. The radio device of claim 3, wherein the radio circuitry uses frequency domain division (FDD) in the cellular and whitespace modes.

7. The radio device of claim 3, wherein the radio circuitry uses time domain division (TDD) in the cellular and whitespace modes.

8. The radio device of claim 1, wherein the radio circuitry comprises electronic circuitry that implements the cellular radio and different electronic circuitry that implements the whitespace radio.

9. The radio device of claim 1, wherein the radio circuitry comprises electronic circuitry that implements at least portions of both the cellular radio and the whitespace radio, the cellular radio and the whitespace radio having respective logical elements.

10. The radio device of claim 9, wherein the radio circuitry is configured to switch between operation in the cellular mode and operation in the whitespace mode, the switching including switching between using frequency domain division (FDD) and time domain division (TDD).

11. The radio device of claim 1, wherein the whitespace mode is inactive when communications using the cellular mode are carried out and the cellular mode is inactive when communications using the whitespace mode are carried out.

12. The radio device of claim 1, wherein the cellular mode is used exclusively for obtaining whitespace authorization from a whitespace management database.

13. The radio device of claim 1, further comprising a control circuit, the control circuit configured to assess plural factors to determine when to use the cellular mode and when to use the whitespace mode.

14. The radio device of claim 1, wherein the radio circuit is further configured to operate as a public safety radio using long term evolution (LTE) protocols and signaling in a public safety mode.

15. The radio device of claim 1, wherein the radio circuit is further configured to operate in non-cellular channels and non-whitespace channels using long term evolution (LTE) protocols and signaling.

16. A whitespace radio device, comprising a radio circuit for establishing whitespace radio communications using long term evolution (LTE) protocols and signaling.

17. The radio device of claim 16, wherein the communications are carried out in a time division duplex (TDD) mode.

18. The radio device of claim 16, wherein the whitespace radio communications are carried out using one or more whitespace channels identified as available in a current whitespace channel list obtained from a whitespace management database.

19. The radio device of claim 18, wherein the available whitespace channels comprise television whitespace channels.
